(19) United States
(12) Patent Application Publication
(10) Pub. No.: US 2018/0181905 A1
(43) Pub. Date: Jun. 28, 2018

(54) METHOD AND SYSTEM FOR MANAGING PHYSICAL ASSETS

(71) Applicant: AssetWorks LLC, Wayne, PA (US)

(72) Inventors: Anthony Charles ROVANO, Cedar Park, TX (US); Daniel Derek HIERHOLZER, San Antonio, TX (US); Claudia Esther PEREZ-CARRADA, San Antonio, TX (US)

(21) Appl. No.: 15/391,809

(22) Filed: Dec. 27, 2016

(51) Int. Cl. G06Q 10/08; H04N 7/18

(52) U.S. Cl. CPC G06Q 10/087; H04N 7/185

(57) ABSTRACT

A system for determining and verifying the location of at least one asset in a facility including a database containing information regarding the identity and location of the at least one asset and the facility; and a mobile computing device retrieving information regarding the at least one asset from the server based on a location in the facility, identifying at least one asset requiring validation of a location of the at least one asset, and receiving input from a user indicative of either a location of the at least one asset being confirmed or a location of the at least one asset being unknown. If the input from the user is indicative of the location being confirmed, the database on the server is updated by creating a data flag indicative of the location of the at least one asset being confirmed.

### TECHNICAL FIELD

The invention relates generally to managing physical assets and data related thereto, and more particularly to a method and system for managing physical assets, obtaining and/or updating data related to the physical assets and providing a mechanism for extracting data from an asset on location.

### BACKGROUND

In the art of facilities management, incomplete asset visibility and information is still a problem, particularly where the number of facilities locations and assets within each location is high. Tracking assets in the prior art generally amounted to a user taking notes, either physically or via a computing device on the location of individual assets and the facility at which they are located. Assets in this context generally refer to any physical item that could be at a facility, including but not limited to, furniture, equipment, tools and other tangible items one would expect to be located within a facility, such as an office or residential building, storage warehouse or other bounded location.

In environments where particular users have access to a number of facilities and assets often travel between facilities, there is often significant time lost to finding assets or ensuring the location of assets is properly tracked. While some similarities exist with inventory control systems, the problems in facilities management are differentiated at least in that assets may be in one of a number of facilities, but should be in a particular facility at any given point in time. Furthermore, coordinating the tracking of inventory is a straightforward task that could be assigned to a single user. In facilities management, it would be beneficial to enable any particular user or individual with any role within the facility to determine the location of an asset, determine which assets are located at a particular facility, verify that a particular asset should be in the facility it is located at and otherwise obtain information about an asset or provide this information to central computer-accessible database.

### SUMMARY OF THE INVENTION

In one embodiment of the invention, there is provided a system for determining and verifying the location of at least one asset in a facility comprising: a database implemented on a computer readable medium of a server; the database containing information regarding the identity and location of the at least one asset and the facility; a mobile computing device including an image capture device, a computer processor and a storage medium containing computer-executable instructions that when executed by the processor: retrieves information regarding the at least one asset from the server based on a location in the facility; identifies at least one asset requiring validation of a location of the at least one asset; receives input from a user indicative of either a location of the at least one asset being confirmed or a location of the at least one asset being unknown. Upon a condition in which the input from the user is indicative of the location being confirmed, updates the database on the server by creating a data flag indicative of the location of the at least one asset being confirmed; and upon a condition in which the input from the user is indicative of the location of the asset being unknown, awaiting input from the user from a different location.

In one aspect of the invention, the server is configured to clear the data flag indicative of the location of the at least one asset being confirmed after a predetermined period of time.

In another aspect of the invention, the predetermined period of time is agnostic to the at least one asset being moved, such that the at least one asset may be physically moved without movement being reflected in the software.

In another aspect of the invention, upon the data flag being cleared, identifying the asset relating to the data flag being cleared as requiring validation.

In another aspect of the invention, the image capture device is a camera and the mobile computing device is a cellular phone.

In another aspect of the invention, the location is determined via GPS.

In another aspect of the invention, n the location is determined via manual input received from a user.

In another aspect of the invention, the computer executable instructions further include instructions to identify all assets requiring location verification.

In another aspect of the invention, the computer executable instructions further include instructions to receive the user input via the image capture device.

In a second embodiment of the invention, there is provided a method for determining and verifying the location of at least one asset in a facility including retrieving information by a mobile computing device regarding the at least one asset from a database implemented on a computer readable medium of a server based on a location in the facility; identifying by a mobile computing device at least one asset requiring validation of a location of the at least one asset; receiving by a mobile computing device input from a user indicative of either a location of the at least one asset being confirmed or a location of the at least one asset being unknown; upon a condition in which the input from the user is indicative of the location being confirmed, updating the database on the server by creating a data flag indicative of the location of the at least one asset being confirmed; and upon a condition in which the input from the user is indicative of the location of the asset being unknown, awaiting input from the user from a different location.

In one aspect of the second embodiment, the method further includes clearing the data flag indicative of the location of the at least one asset being confirmed after a predetermined period of time.

In another aspect of the second embodiment, the predetermined period of time is agnostic to the at least one asset being moved.

In another aspect of the second embodiment, upon the data flag being cleared, identifying the asset relating to the data flag being cleared as requiring validation.

In another aspect of the second embodiment, the image capture device is a camera and the mobile computing device is a cellular phone, tablet or other device capable of wireless communication.

In another aspect of the second embodiment, the location is determined via GPS.

In another aspect of the second embodiment, the location is determined via manual input received from a user.

In another aspect of the second embodiment, the method further includes identifying all assets requiring location verification.

In another aspect of the second embodiment, the method further includes receiving the user input via the image capture device.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a schematic illustration of hardware used to carry out embodiments of the invention.

FIG. 2 is a schematic illustration of properties and assets to which the invention is applied.

FIG. 3 illustrates a computer system used to implement various hardware devices used in the invention.

FIGS. 4-13 show various screen shots of an exemplary software implementation of the invention.

FIG. 14 is a flowchart illustrating one aspect of the invention.

### DETAILED DESCRIPTION OF THE INVENTION

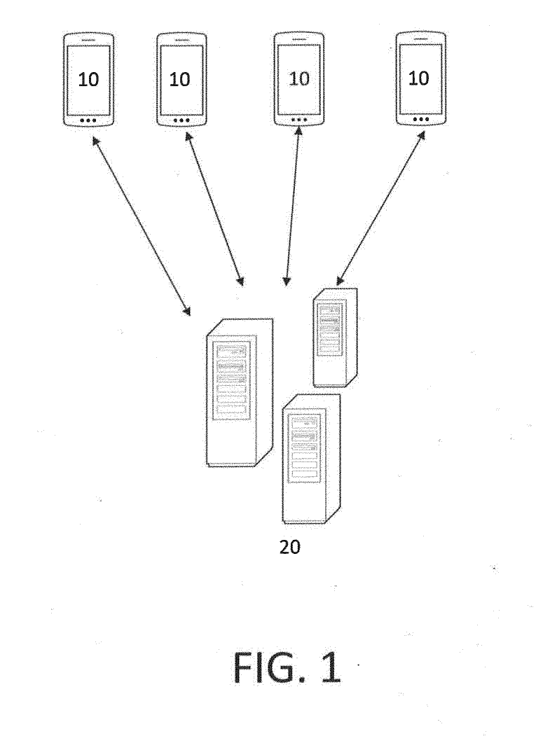

Embodiments of the invention described below are made with reference to the drawings which show various features implemented on a mobile device or smartphone. However, it is equally conceivable that customized and specialized hardware devices configured in an analogous manner may be used. FIG. 1 shows a plurality of mobile devices 10 in wireless communication with one or more data servers 20. The mobile devices are kept on the person of individual users traversing the facilities under management and are adapted to correspond with the one or more data servers 20. There may be any number of mobile devices so configured, including only a single one at any given time. Mobile devices 10 also include a camera or other optical recognition system capable of taking a photograph, reading a bar code or otherwise processing indicia on assets at a facility.

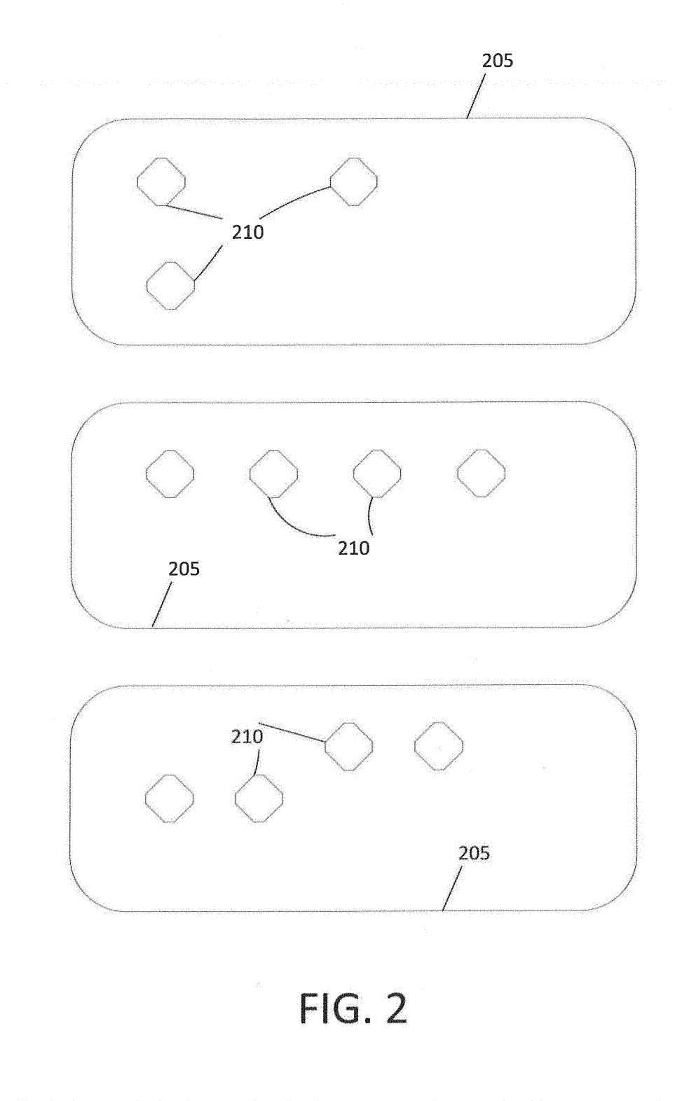

In general use, and as shown in FIG. 2, a plurality of facility locations 205 are shown, each having one or more assets 210. In practice, it is also conceivable that a particular location has no assets within it. The facility locations may be offices, storage locations, commercial or residential buildings and other bounded structures, or any combination of the above. Each facility location may also be subdivided into a number of areas within the facility, typically rooms which are readily identifiable. Assets 210 are generally any elements that may be moved within and/or between facilities and could include equipment, furniture, tools and other objects that are not permanently affixed to a facility. In normal operations, it is likely that any given asset 210 may be moved from one room to another in a facility or to another facility altogether. These transactions of moving assets may occur quite frequently and often by personnel who are not otherwise responsible for or capable of identifying where an asset should normally be. The invention thus provides a potential solution to this problem by empowering any personnel with a mobile device 10 to glean information about an asset or identify where an asset is or should be located.

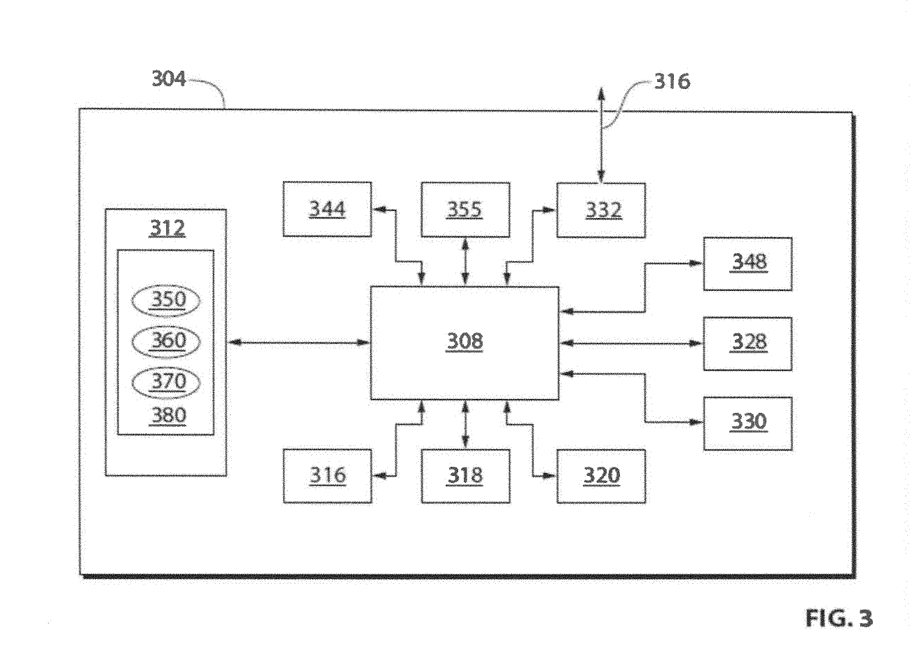

Mobile devices 10 and data servers 20 are all separate computer systems capable of interacting with each other as herein described. The computer systems forming the aforementioned elements are exemplified in FIG. 3, although individual computer systems may not include all of the elements in FIG. 3, where computing device 304 includes at least one main processor 308 that controls the overall operation of the computing device 304. The computing device 304 is interconnected with a non-transitory computer readable storage medium such as a memory 312. Memory 312 can be any desired combination of volatile (i.e., RAM) and non-volatile (i.e., ROM), including Electrically Erasable Programmable Read Only Memory (“EEPROM”), flash memory, magnetic computer storage device, or optical disc memory.

Computing device 304 also includes one or more input devices interconnected with main processor 308. Such input devices are configured to receive input and provide data representative of such input to processor 308. Input devices can include, for example, a keypad 316 and a pointing device 318. Thus, keypad 316 can receive input in the form of the depression of one or more keys, and can then provide data representative of such input to processor 308. In variations, a keyboard can be implemented as a soft keyboard relying on a touch screen, for example. A pointing device can be implemented as a computer mouse, track ball, track wheel, touchscreen, and the like. In some examples, such as with on board computer 222, a computing device can include additional input devices in the form of one or more additional buttons, light sensors, microphones and the like. Pointing device 318 can receive input in the form of movement, pressure or swipe gestures, and can then provide data representative of such input to processor 308 in the form of, for example, coordinates representing the location of a virtual cursor, the direction and/or velocity of a swipe gesture, and the like.

Computing device 304 further includes one or more output devices. The output devices of computing device 304 include a display 320. Display 320 includes display circuitry controllable by processor 308 for generating interfaces which include representations of data and/or applications maintained in memory 312. The display circuitry can thus include any suitable combination of display buffers, transistors, LCD cells, plasma cells, phosphors, LEDs and the like. When the input devices of computing device 304 include a touch screen input device, the touch screen (not shown) can be integrated with display 320. The output devices of computing device 304 can also include a speaker 328 interconnected with processor 308. Additional output devices are also contemplated.

Computing device 304 also includes a communications interface 332 interconnected with processor 308. Communications interface 332 allows computing device 304 to perform voice and/or data communications via a link 336, which can be wired and/or wireless, and, where appropriate, with or via a network such as 240. The communication interface 332 receives messages from and sends messages through link 336.

Computing device 304 maintains, in memory 312, one or more files containing a plurality of computer readable instructions and/or data. Typically, files are organized in accordance with a structure and logic referred to as a file system. In this illustrative example, file system 380 maintained in memory 312 represents the structure and organization of files accessible by computing device 304.

Files are typically stored in a non-volatile portion of memory 312 such as a solid state disk or a hard drive. In variations, the files can be stored in other portions of memory 312 such as in volatile memory or in a combination of different portions. In yet other variations, some of the files may be stored in memory or storage locations that are external to computing device 304, such as those maintained at network-based cloud storage. The location of files can also vary based on the operational state of the computing device 304. For example, files may be maintained in a non-volatile portion of memory 312 when the computing device is turned off. However, at least some of the files may be moved into a volatile portion of memory 312 as the computer device 304 is powered up, or otherwise rendered operational. In variations, files may be moved to volatile memory as the files are accessed by processor 308. Other combinations of memory 312 portions and operational states for storing files within memory 312 will now occur to a person of skill and are contemplated.

Details of the invention below will be described with respect to features of functionality of the software on the mobile device 10, one of the servers 20 or a combination of the two, however it will be appreciated by one skilled in the art that the specific features and functionality of software described and illustrated are for illustrative purposes only and it is the interactions of features and modification of a standard mobile device into a specialized mobile device capable of carrying out the invention that is considered unique.

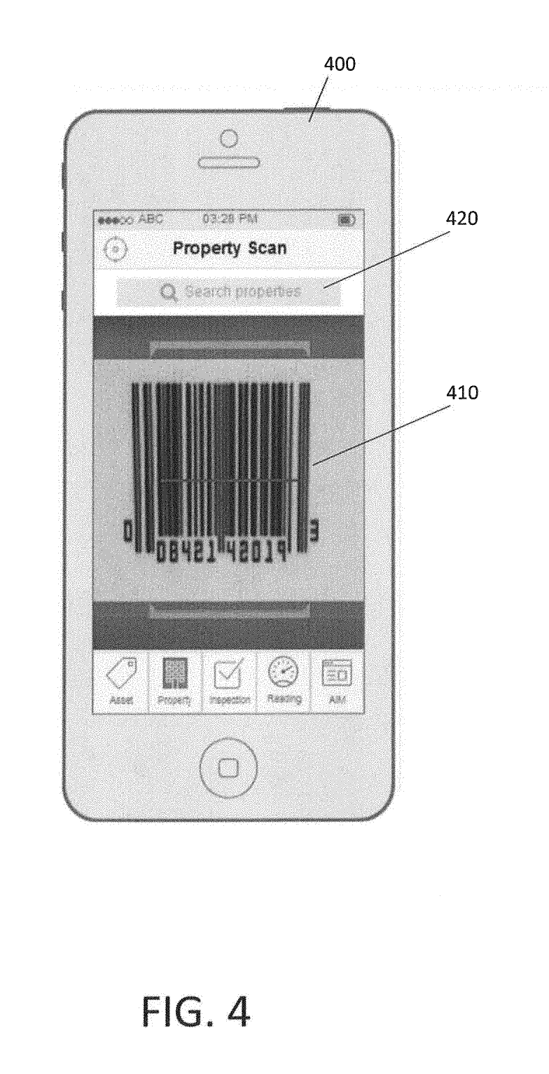

With reference now to FIG. 4, there is shown an initial screen 400 which enables the capture of information of an asset by a user. While a barcode 410 is shown, other optical recognition capabilities are considered as well. A user may scan (i.e., using the camera on the mobile device capture an image of the barcode or other indicia) an asset, geolocate an asset based on its last known location or search for an asset or location.

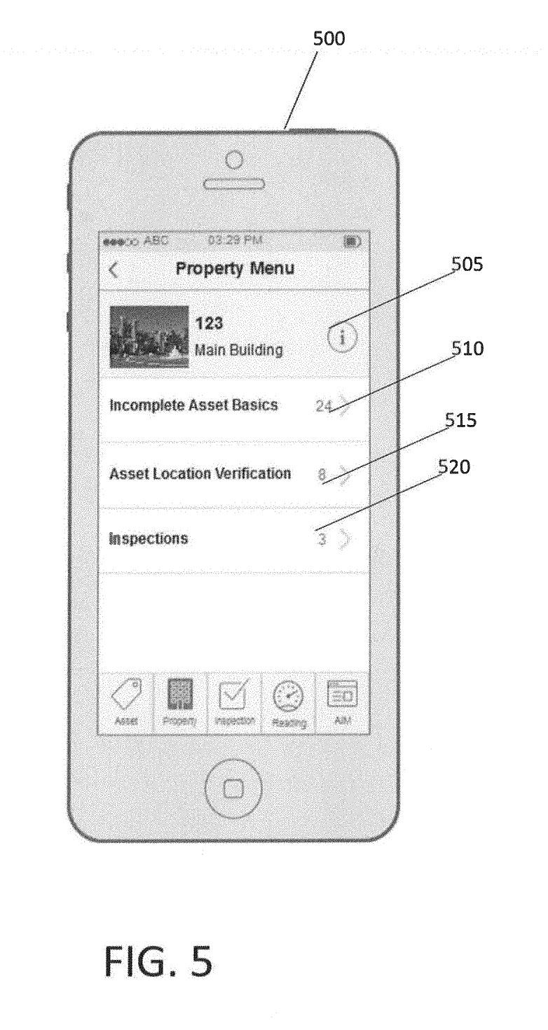

The search field 420 is used to search for a facility and can take exemplary inputs from a user such as facility name, address, description, etc. If the result of the search is unique, then the user is provided details of the unique facility search result and options for acting on the assets within that facility via the Property Menu, shown in FIG. 5. If the result of the search is not unique (for example, if the user searches for “storage” and multiple facilities are categorized as storage) then a complete asset list of all properties is displayed via the Asset List Screen.

When using the bar code scan, the user may scan a barcode or other indicia associated with a property. The scan could be taken from a list or on location itself If the result of the scan is unique, the Property Menu is displayed. If the result is not unique then a Property List Screen is displayed.

The Property Menu 500 is shown in FIG. 5, and presents the user with basic details of the property vis a vis its assets. In the illustrated embodiment, a “123 Main Building” is shown at 505. The user is then presented with three options that may be taken from this menu. First, under Incomplete Asset Basics 510, the number of assets at this property missing basic information is displayed. The user may click thru to get to the Property Asset Basics list screen. Under Asset Location Verification 515, there is shown the number of assets thought to be on the property, but whose presence has not been verified. Clicking thru from here presents the Property Asset Location Verify screen. Finally, under Inspections 520, the number of incomplete inspections for this property is shown, and the user may click thru to the Inspections screen.

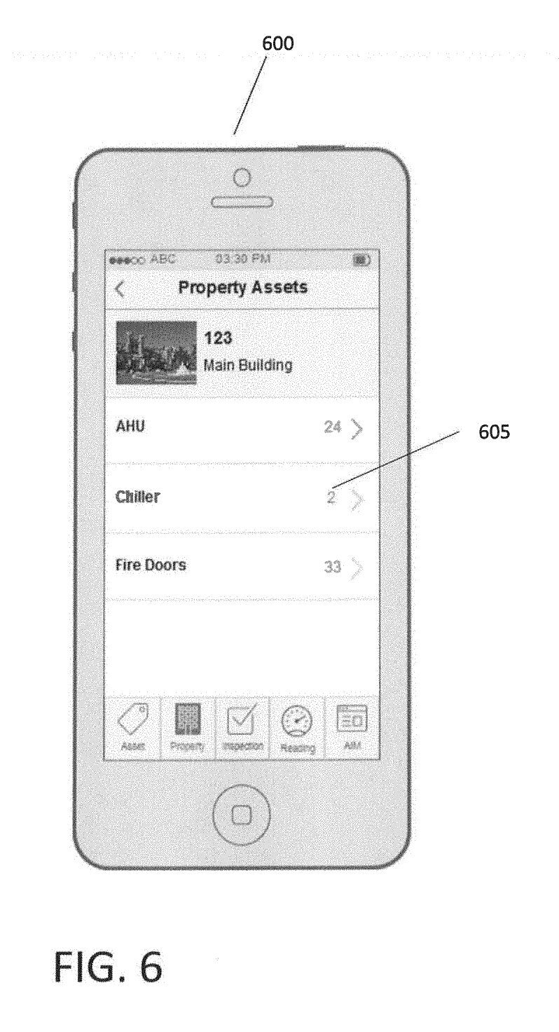

If a user selected the property itself in FIG. 5, the list of asset types 600 contained within this property is displayed as shown in FIG. 6. The user may drill down to see the list of individual assets by clicking on any one of the asset types 605.

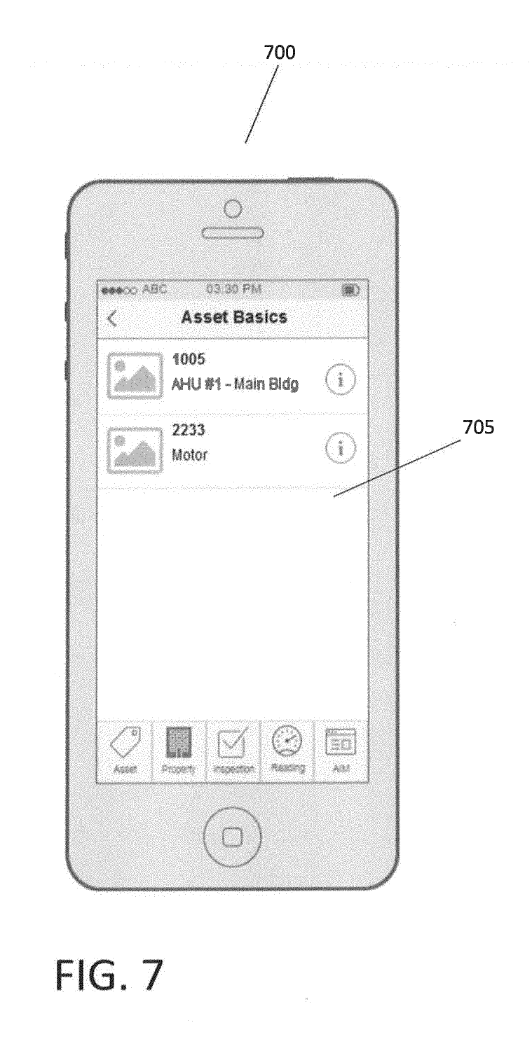

FIG. 7 shows the Asset Basics screen, which is filtered for the selected property. This screen 700 contains a list of assets 705 associated with the property that are missing asset basics information. Selecting any of the assets will show specifics of the missing information, allowing a user to enter the missing information if readily available or to initiate another process of discovering the missing information.

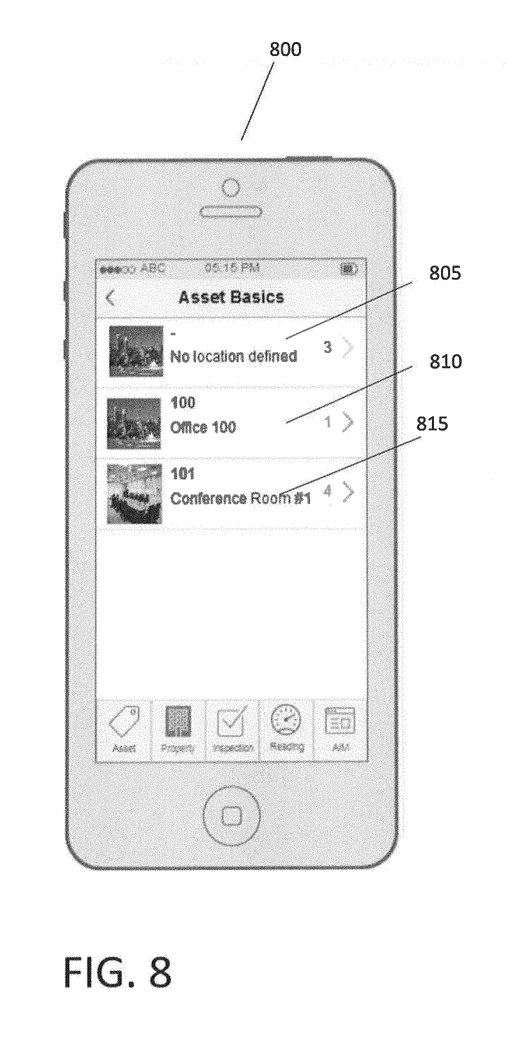

FIG. 8 illustrates an embodiment where assets with missing information is shown within a particular property, but filtered by location within that property. The screen 800 shown categories the assets by location within the property. For example, at 805 there is shown 3 assets with unknown location information, 1 asset in Office 100 at 810 is missing a different piece of information and 4 assets in the Conference Room #1 at 815 are missing certain asset basics information. The screen space 805 also includes of photograph of the location. For users who may not be familiar with specific location names, such as “Office 100” vs. “Office 200”, the photograph may be beneficial. If no location photo exists, then a general photograph of the property may be shown.

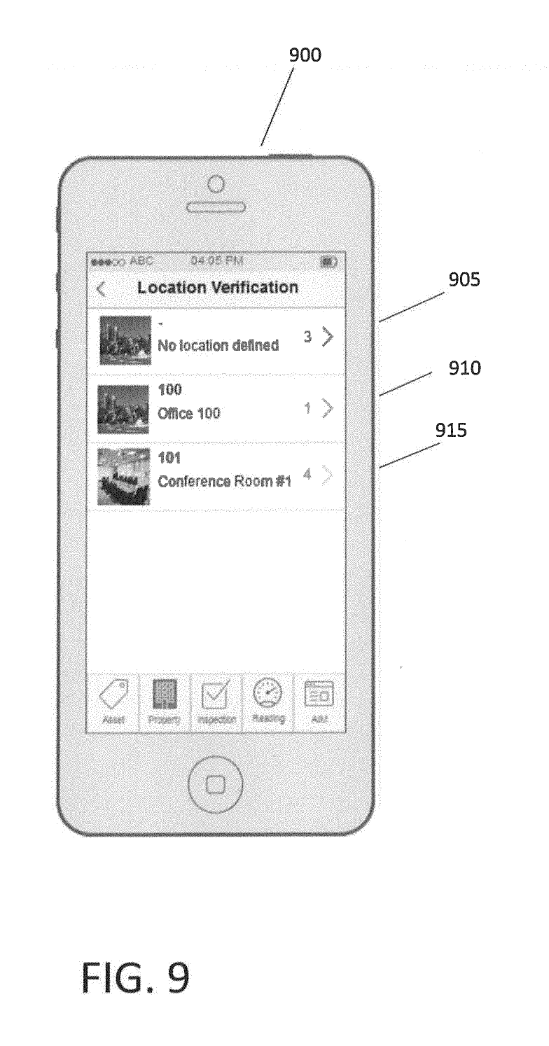

FIG. 9 is a Location Verification screen 900, which allows a user to verify the presence of assets in the property. The assets are categorized by location within the property and is otherwise similar to the screen of FIG. 8. Drilling down on one of the items 905, 910 or 915 brings the user to the Location Verify screen. The line items 905, 910 and 915 show the number of assets within the particular locations shown.

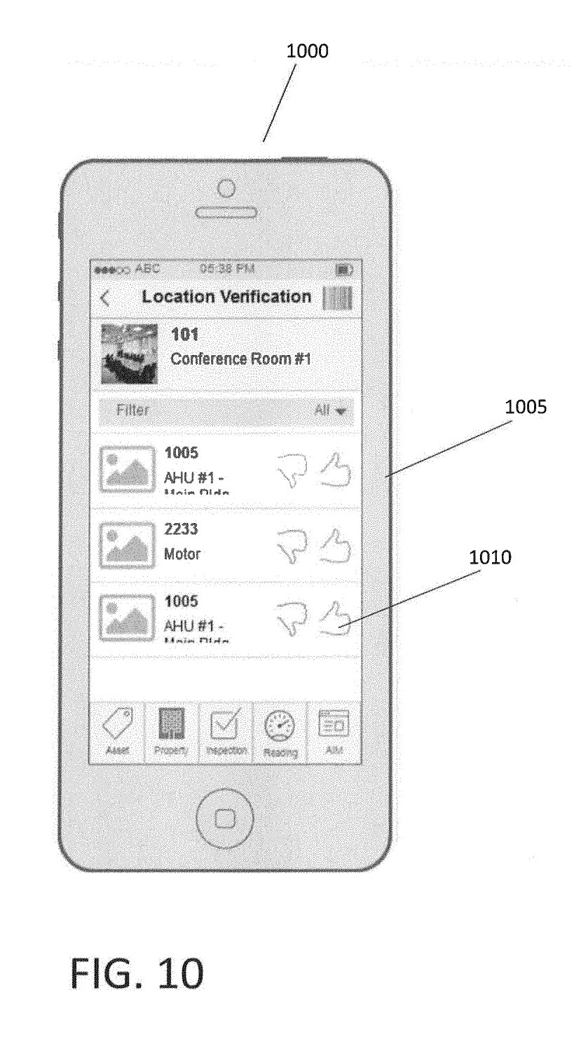

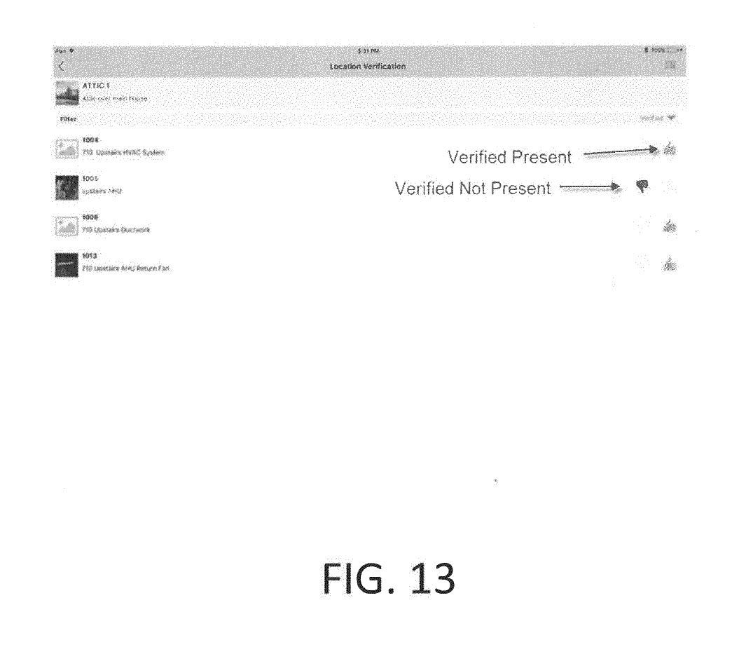

FIG. 10 shows the Location Verify screen 1000, which is a drill down from one of the line items 905, 910 or 915 in FIG. 9. The screen 1000 shows the room having been selected, in this case, Conference Room 915, and below lists each of the assets 1005 within the selected location. The user is permitted to identify that the asset is indeed within the selected location or is not, for example by selecting the “thumbs up” or “thumbs down” indicators 1010, as shown in FIG. 13. Once the user makes this selection, the database (of FIG. 1) is updated and thus provides information on whether the asset is in the location or not to other users of the application.

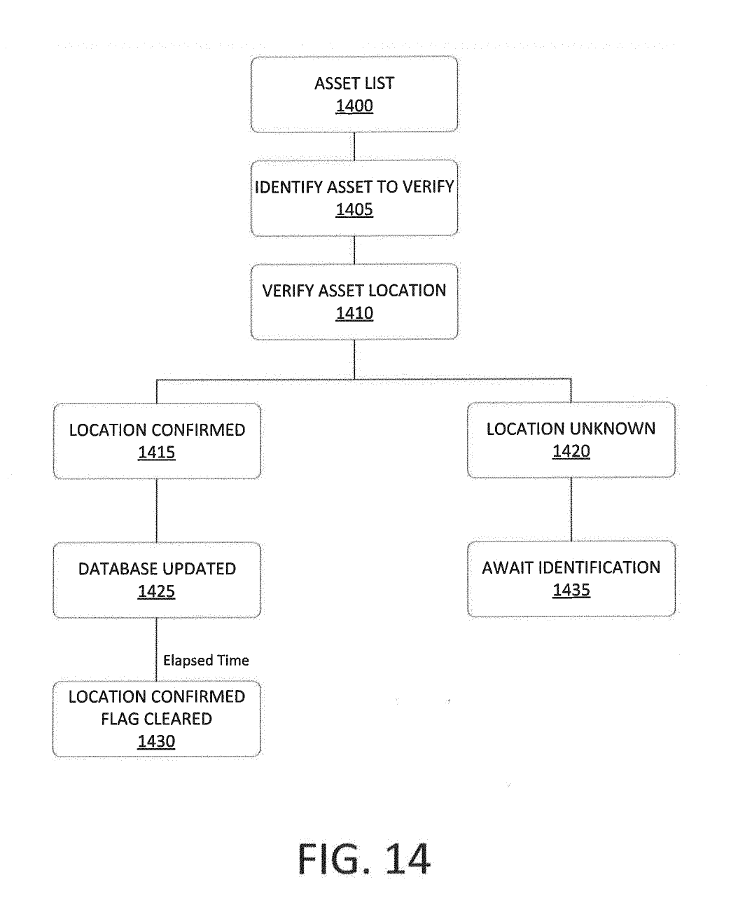

The software is also configured to store location verification information for a predetermined period of time. After the predetermined period of time, the verification information is cleared and set back to being unknown and the next user who comes across the asset is triggered to verify the location of the asset again. This periodic wiping of location verification information enforces a policy whereby location information of an asset is forced to be updated on a periodic basis in the event an asset is moved by a user who is not equipped with software carrying out the invention. This decision logic of this feature is also further illustrated in FIG. 14 where at step 1400 the user access the asset list for a given location and identifies an asset whose location needs verification at step 1405. At step 1410, the user verifies the location of the asset as either being present 1415 or not present 1420. In the case where the location is confirmed, the database is updated with a location verified flag at step 1425. After some elapsed time, and to account for the possibility that the asset may be moved by another person without updating the location, the location verified flag is cleared at step 1430, and the next time the user (or a different user) enters that location, the process starts over and the user may verify the location of the asset. This ensures that “location confirmed” information does not subsist in the database indefinitely even when the asset has been moved, and forces an active verification by a user.

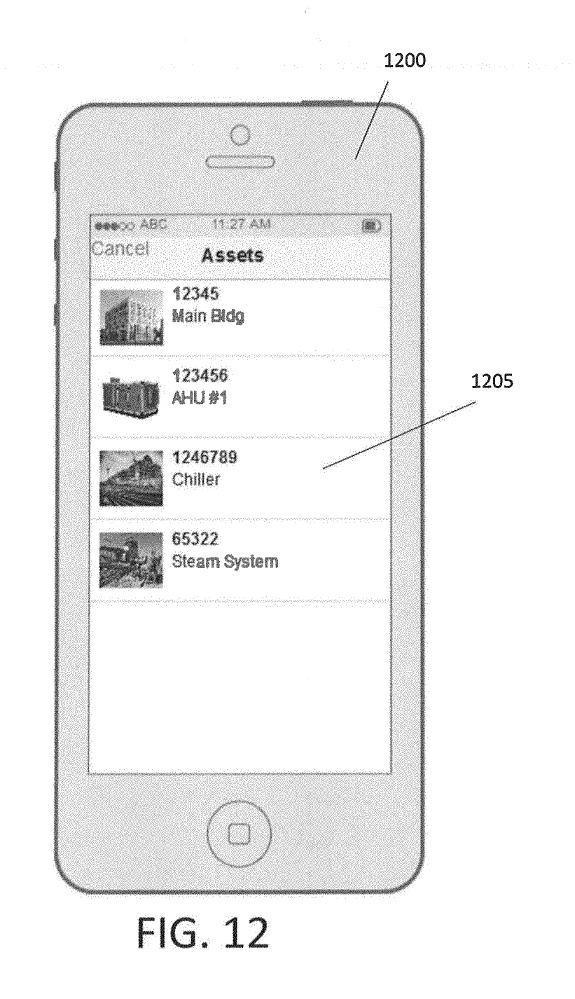

On the other side, if the location is indicated to be unknown as in step 1420, it is shown on the Asset List screen of FIG. 12 and its location is updated the next time a user comes across the asset in a different location.

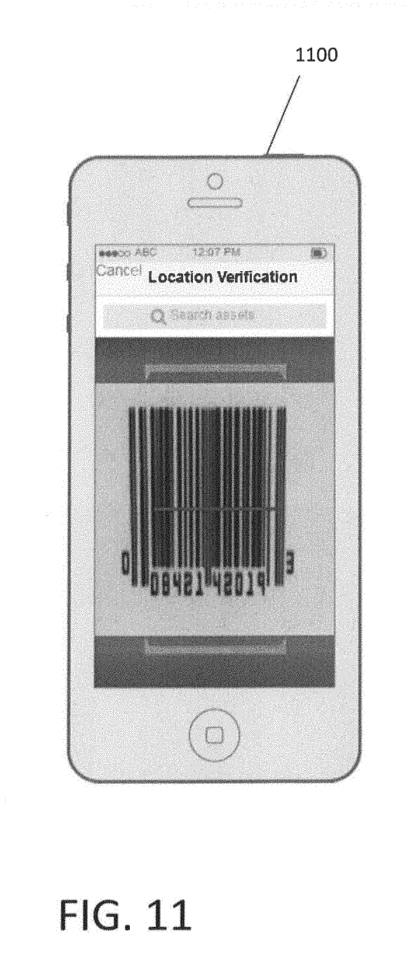

Alternatively, and as shown in FIG. 11, a user may selected a bar code scan option 1100 to scan a bar code (or other indicia) on each of the assets to thereby confirm their presence.

Referring now to FIG. 12, there is shown an embodiment of the invention, which permits users to bring up a list of all assets under control within each of the facilities. As shown, on this Asset List screen 1200, the user has selected the location of the Main Building, and a number of assets 1205 are shown to be within the building.

If a user selects on the of the assets 1205, the invention provides one of the following responses: (a) the selected asset is found and its location in the selected property is confirmed, (b) the asset is found in another location and the user is given the option of relocating to that location, (c) the asset is not found and the user is given the option of creating the asset within the database on the server. Creating the asset generates a new item in the database and the newly created asset is treated like any other asset herein described.

It will be apparent to one of skill in the art that other configurations, hardware etc. may be used in any of the foregoing embodiments of the products, methods, and systems of this invention. It will be understood that the specification is illustrative of the present invention and that other embodiments within the spirit and scope of the invention will suggest themselves to those skilled in the art. All references cited herein are incorporated by reference.

What is claimed is:

1. A system for determining and verifying the location of at least one asset in a facility comprising:
a database implemented on a computer readable medium of a server;
said database containing information regarding the identity and location of the at least one asset and the facility;
a mobile computing device including an image capture device, a computer processor and a storage medium containing computer-executable instructions that when executed by said processor:
retrieves information regarding the at least one asset from said server based on a location in said facility;
identifies at least one asset requiring validation of a location of said at least one asset;
receives input from a user indicative of either a location of said at least one asset being confirmed or a location of said at least one asset being unknown;
upon a condition in which said input from said user is indicative of the location being confirmed, updates said database on said server by creating a data flag indicative of the location of said at least one asset being confirmed; and
upon a condition in which said input from said user is indicative of the location of the asset being unknown, awaiting input from the user from a different location.

2. The system according to claim 1, wherein said server is configured to clear said data flag indicative of the location of said at least one asset being confirmed after a predetermined period of time.

3. The system according to claim 2, wherein said predetermined period of time is agnostic to said at least one asset being moved.

4. The system according to claim 2, wherein upon said data flag being cleared, identifying said asset relating to said data flag being cleared as requiring validation.

5. The system according to claim 1, wherein said image capture device is a camera and said mobile computing device is a cellular phone.

6. The system according to claim 1, wherein said location is determined via GPS.

7. The system according to claim 1, wherein said location is determined via manual input received from a user.

8. The system according to claim 1, wherein said computer executable instructions further include instructions to identify all assets requiring location verification.

9. The system according to claim 1, wherein said computer executable instructions further include instructions to receive said user input via said image capture device.

10. A method for determining and verifying the location of at least one asset in a facility comprising:
retrieving information by a mobile computing device regarding the at least one asset from a database implemented on a computer readable medium of a server based on a location in said facility;
identifying by a mobile computing device at least one asset requiring validation of a location of said at least one asset;
receiving by a mobile computing device input from a user indicative of either a location of said at least one asset being confirmed or a location of said at least one asset being unknown;
upon a condition in which said input from said user is indicative of the location being confirmed, updating said database on said server by creating a data flag indicative of the location of said at least one asset being confirmed; and
upon a condition in which said input from said user is indicative of the location of the asset being unknown, awaiting input from the user from a different location.

11. The method according to claim 10, further comprising clearing said data flag indicative of the location of said at least one asset being confirmed after a predetermined period of time.

12. The method according to claim 11, wherein said predetermined period of time is agnostic to said at least one asset being moved.

13. The method according to claim 11, wherein upon said data flag being cleared, identifying said asset relating to said data flag being cleared as requiring validation.

14. The method according to claim 10, wherein said image capture device is a camera and said mobile computing device is a cellular phone.

15. The method according to claim 10, wherein said location is determined via GPS.

16. The method according to claim 10, wherein said location is determined via manual input received from a user.

17. The method according to claim 10, further comprising identifying all assets requiring location verification.

18. The method according to claim 1, further comprising receiving said user input via said image capture device.
